(19) United States
(12) Patent Application Publication
(10) Pub. No.: US 2006/0121230 A1
(43) Pub. Date: Jun. 8, 2006

(54) System and method for assessing the aesthetic compatibility of design elements

(75) Inventor: Donna J. Neerhout, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: Neerhout Communications, LLC

(21) Appl. No.: 11/297,247

(22) Filed: Dec. 7, 2005

Related U.S. Application Data
(60) Provisional application No. 60/634,143, filed on Dec. 7, 2004.

(51) Int. Cl. B32B 33/00

(52) U.S. Cl. 428/40.1

(57) ABSTRACT

A system for assessing the aesthetic compatibility of design elements. The system includes a sheet and an insert. The sheet includes a sheet surface that is substantially planar, and is configured to receive at least one design element, and a receiving region having a sheet engagement portion. The insert is dimensioned to fit within the receiving region, and includes an insert surface, and an insert engagement portion. The insert surface is substantially planar, and is configured to receive at least one design element. The insert engagement portion is configured to engage with the sheet engagement portion in a manner that removably secures the insert within the receiving region in a secured position, whereby the sheet surface substantially adjoins the insert surface.

### CROSS-REFERENCE TO RELATED APPLICATION

This application claims, under 35 U.S.C. § 119(e), the benefit of U.S. Provisional Patent Application Ser. No. 60/634,143 entitled “Paint Color Selection System,” filed Dec. 7, 2004, the complete disclosure of which is herein incorporated by reference for all purposes.

### BACKGROUND

A decorator or designer may be required to apply a wide variety of design elements to the various regions on or within a structure's rooms or surfaces. For example, in any particular room, a designer may be required to select various colors, textures and patterns of paints, stains, lacquers, veneers, wallpapers, tiles, fabrics, woods, metals, carpets, etc. A decorator is frequently required to select these various design elements based on their aesthetic compatibility relative to each other, and/or to the structure itself.

Although many manufacturers of design elements provide samples of the various colors, textures, and patterns that they have available, it is often difficult to use these samples to assess each design element's compatibility with other design elements, and/or with the structure the designer wishes to decorate. For example, although paint manufacturers offer paint swatches or chips to help with paint selection, it is often difficult to determine how a color will ultimately look based on a 1″×2″ paper sample. In addition, paint manufacturers often display a gradation of color shades on a single swatch making it difficult to discern the actual color of a single paint sample due to the visual influence of the other shades surrounding it. It is even more difficult to compare a single paint sample with another design element, such as a fabric, or a wallpaper.

### SUMMARY

Systems and methods are therefore disclosed, which enable a designer to easily assess the aesthetic compatibility of design elements relative to each other and/or to a structure. Examples of other systems for selecting design elements are found in U.S. Pat. Nos. 750,620; 786,210; 856,222; 886,057; 898,290; 910,240; 1,057,546; 1,070,891; 3,559,306; 4,457,718; 4,458,435; 5,743,407; 5,855,480; and 5,985,413, the disclosures of which are hereby incorporated by reference in their entirety for all purposes.

### BRIEF DESCRIPTION OF THE DRAWINGS

FIG. 1 shows a system for assessing the aesthetic compatibility of design elements.

FIG. 2 shows a side view of a sheet and an adhesive substance from the system shown in FIG. 1, where the adhesive substance is selectively adhered to either a front surface or a back surface of the sheet.

FIG. 3 shows a profile view of aspects of the system shown in FIG. 1.

### DETAILED DESCRIPTION OF THE INVENTION

The present teachings provide a system and method for assessing the compatibility of design elements. In general, the system may include a sheet, one or more inserts, an adhesive substance, and/or one or more labels.

The sheet may include a sheet surface, and one or more receiving regions. The sheet surface may be substantially planar, and may be configured to receive at least one design element. Each receiving region may be configured to receive one or more corresponding inserts, and may include a sheet engagement portion.

Each insert may be dimensioned to fit within one or more corresponding receiving regions, and may include an insert surface, and an insert engagement portion. The insert surface may be substantially planar, and may be configured to receive at least one design element. The insert engagement portion may be configured to engage with the sheet engagement portion of the corresponding receiving region in a manner that removably secures the insert within the receiving region in a secured position, whereby the sheet surface substantially adjoins the insert surface.

The adhesive substance may be configured to adhere to, and removably secure the sheet and/or the insert to one or more structural surfaces.

The label may be configured to receive written information, and to attach to the sheet surface, to the insert surface, and/or to design elements applied to the sheet or insert surfaces.

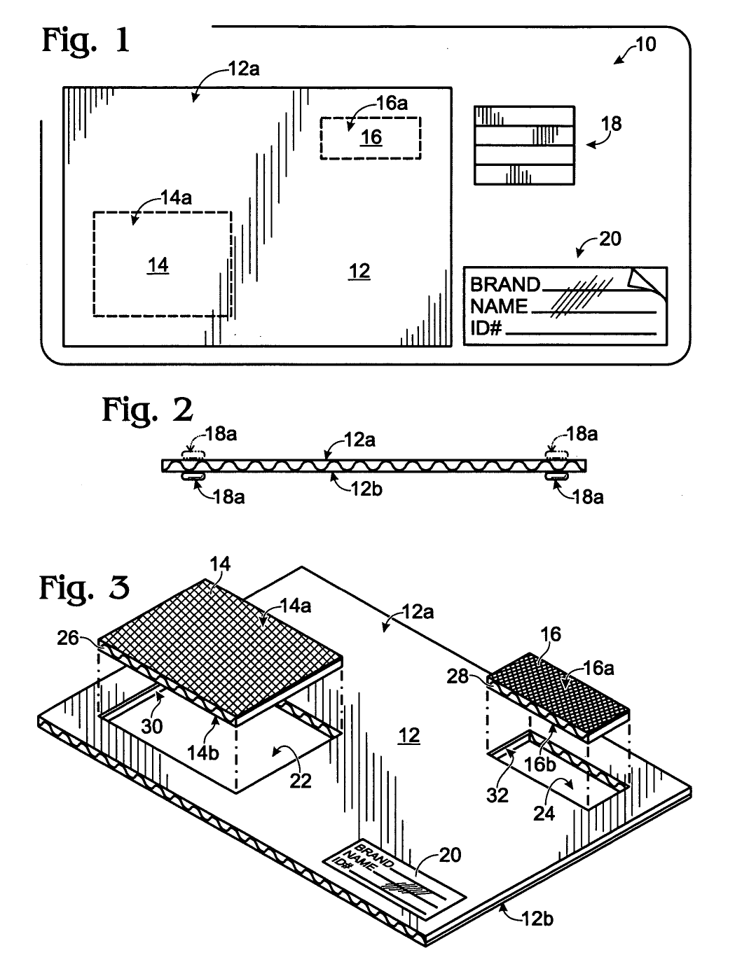

FIGS. 1-3 show an exemplary embodiment of a system for assessing the compatibility of design elements. The system 10 may include a sheet 12 from which one or more inserts 14, 16 have been cut. The system may also include an adhesive substance 18, and/or labels 20.

As shown in FIGS. 1-3, the sheet 12 may include sheet surfaces 12a-b. The sheet surfaces 12a-b may be substantially opposed surfaces that face in opposite directions on either side of the sheet. Each sheet surface may be a substantially planar surface configured to receive at least one design element, as described in more detail below. The sheet may be any size and shape. For example, the sheet may be a rectangular sheet measuring approximately 22″×28″. The sheet may also be made of any suitable material, such as corrugated cardboard, poster board, or any other light weight material suitable for receiving design elements. The sheet may be formed of semi-rigid materials that cause the sheet to substantially retain its shape under ordinary use.

The dotted lines shown in FIG. 1 indicate that the sheet 12 may be perforated or precisely cut in a manner that enables a user to punch out and separate one or more inserts 14, 16 from the remainder of the sheet. Precision cuts in the sheet may be laser-cuts, die-cuts, or any other suitable cut. Because each insert may be cut from the same material as the sheet, each insert may be made of the same material as the sheet. Each insert may also include insert surfaces 14a-b, 16a-b that may be made of the same material as the sheet surfaces 12a-b. Each insert may be any size and shape. For example, some inserts may be rectangular, and may measure approximately 12½″×11″. Other inserts may measure approximately 7½×″×3½″. Further, any particular insert may be the same or a different size and shape as the other inserts.

Upon removing the inserts from the sheet, receiving regions 22, 24 may be formed in the sheet 12. Each receiving region may be configured to receive inserts having a size and shape corresponding to the size and shape of the receiving region. For example, receiving region 22 may be configured to receive corresponding insert 14, and receiving region 24 may be configured to receive corresponding insert 16. Each receiving region may be a window through the sheet that is partially or completely surrounded by the sheet, and into which a corresponding insert may be received.

Each insert 14, 16 and each receiving region 22, 24, may include an engagement portion that enables a user to removably secure each insert within a corresponding receiving region. For example, as best shown in FIG. 3, the cuts used to generate insert 14 may also generate an edge 26 of the insert 14, and an edge 30 of the corresponding receiving region 22, whereby the edge 30 is adjacent to the sheet surfaces 12a-b, and has a longitudinal axis that diverges from the longitudinal axis of either sheet surface. The cuts may be thin enough such that positioning insert 14 within corresponding receiving region 22 may cause the edge 26 of the insert (i.e. insert engagement portion 26) to frictionally engage the edge 30 of the corresponding receiving region (i.e. sheet engagement portion 30). The insert 14 may thereby be secured within the corresponding receiving region 22 in a secured position, whereby the sheet surface 12a substantially adjoins and/or is co-planar with the insert surface 14a, and the sheet surface 12b substantially adjoins and/or is co-planar with the insert surface 14b.

Likewise, the cuts used to generate insert 16 may also generate an edge 28 of the insert 16, and an edge 32 of the corresponding receiving region 24, whereby the edge 32 is adjacent to the sheet surfaces 12a-b, and has a longitudinal axis that diverges from the longitudinal axis of either sheet surface. The cuts may be thin enough such that positioning insert 16 within the corresponding receiving region 24 may cause the edge 28 of the insert (i.e. insert engagement portion 28) to frictionally engage the edge 32 of the corresponding receiving region (i.e. sheet engagement portion 32). The insert 16 may thereby be secured within the corresponding receiving region 24 in a secured position, whereby the sheet surface 12a substantially adjoins and/or is co-planar with the insert surface 16a, and the sheet surface 12b substantially adjoins and/or is co-planar with the insert surface 16b.

Each insert 14, 16 may be reversible within each corresponding receiving region 22, 24. Because each insert may be pre-cut for removal from the sheet, each insert may be flipped over and removably secured within the corresponding receiving region 22, 24. For example, insert 14 may be secured within the corresponding receiving region 22 in a reverse secured position, whereby the sheet surface 12a substantially adjoins and/or is co-planar with the insert surface 14b, and the sheet surface 12b substantially adjoins and/or is co-planar with the insert surface 14a. Likewise, insert 16 may be secured within the corresponding receiving region 24 in a reverse secured position, whereby the sheet surface 12a substantially adjoins and/or is co-planar with the insert surface 16b, and the sheet surface 12b substantially adjoins and/or is co-planar with the insert surface 16a.

Because each insert is easily removed from, and secured within, each corresponding receiving region, the system is ideal for use in selectively assessing the aesthetic compatibility of design elements. As indicated above, the sheet surface and the insert surfaces are configured to receive at least one design element. For example, the sheet and/or insert surfaces may be configured to readily receive paint. The sheet and/or inserts may also be configured to readily receive permanent or removable adhesive for affixing fabric, paper, wallpaper, tile, wood, or carpet. The surface may also be configured to receive stains, lacquers, veneers, plasters, earthen plasters, bricks, or any other design element that may be used on or within a structure. Design elements may be applied to one or both sheet surfaces, and/or to one or both insert surfaces. Thereafter, any particular insert may be selectively secured within the corresponding receiving region in either the secured or the reverse secured position, whereby the desired design elements are selectively positioned to adjoin each other. The inserts can also be removed altogether, whereby a window is created through the sheet. Such a window may thus enable a user to look through the sheet at another surface for comparison with one or more design elements on either of the sheet surfaces. The system thereby enables a user to easily assess the aesthetic compatibility of specific combinations of design elements.

For example, a first design element may be applied to the sheet surface 12a, and a second design element may be applied to the insert surface 14a. The insert 14 may then be secured within receiving region 22 in the secured position, whereby the sheet surface 12a substantially adjoins the insert surface 14a, and the first design element substantially adjoins the second design element. A user may then assess the aesthetic compatibility of the first design element relative to the second design element.

After assessing the compatibility of the first design element relative to the second design element, the user then may: remove the insert 14; apply a third design element to the opposed insert surface 14b; and secure the insert within the receiving portion 22 in the reverse secured position, whereby the sheet surface 12a substantially adjoins the insert surface 14b, and the first design element substantially adjoins the third design element. The user may thereafter assess the aesthetic compatibility of the first design element relative to the third design element. Further, the user may compare the aesthetic compatibility of the first design element relative to the second design element with the aesthetic compatibility of the first design element relative to the third design element.

As shown in FIGS. 1 and 2, the system may include an adhesive substance 18 configured to adhere to, and removably secure the sheet 12 and/or an insert 14, 16 to one or more surfaces of a structure. For example, the adhesive may be a malleable adhesive putty that is torn into smaller pieces 18a as needed to removably secure the sheet to a surface. As shown in FIG. 2, the adhesive may be selectively adhered to either, or both, of the sheet's sides. If the sheet has already received a design element, then depending on the nature of the design element, the adhesive substance may be adhered directly to the design element. Although there is no proscribed placement, typically a user places a small amount of adhesive on each of the four corners of the sheet. After applying the adhesive to the sheet, the user presses the sheet against a desired surface (with the adhesive side facing the surface) until the sheet is secured to the desired surface. The user may then stand away from the surface to evaluate the various design elements applied to the sheet and/or inserts, relative to the structure. To remove the sample, the user may simply pull the sheet and the attached adhesive substance 18a away from the surface. They user may then repeat this process on other surfaces so as to evaluate the various design elements applied to the sheet and/or inserts in different levels of light and shadow.

As shown in FIGS. 1 and 3, system 10 may include labels 20 that are configured to receive written information. When using one or more sheets and/or inserts to evaluate multiple design elements, it is important that a user be able to record information about each design element for future reference, particularly when evaluating design elements having similar appearance (such as similar shades of paint). Labels 20 may therefore have an adhesive back for affixing the label directly to a design element applied to either the sheet surfaces or the insert surfaces. The labels may be removable, so as to enable a user to reuse the sheet and/or insert portion (such as by painting over an old paint color). Some labels may prompt the user to enter discrete information, such as a design element's name, manufacturer, brand, identification number, manufacturer's code, etc. Some labels may have an opaque background that enables a user to see through the label, and see the design element behind the label. The labels may be any appropriate size or shape.

Many variations of the disclosed systems and methods are possible. For example, inserts may be proportioned to fit within the receiving regions of several different sheets. Sheets may include receiving regions that border the sheet's edge, such that securing an insert within the receiving region causes the insert to form part of the system's edge. Multiple systems and sheets may be compared to one another. Alternatively, a comparison surface (similar to an insert surface) may be presented through a window in a sheet by placing the insert within a pocket positioned behind the window. The pocket may thus function as a receiving region having engagement portions that removably secure the insert within the receiving region. A comparison surface may also be secured to areas on one or more of the sheet surfaces with a securing mechanism, such as an adhesive, hook and loop fasteners, or any other type of securing mechanism. Design elements attached to these alternative comparison surfaces may be compared with design elements attached to the sheet surfaces for the purpose of assessing their aesthetic compatibility.

It is believed that this disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

I claim:

1. A system for assessing the aesthetic compatibility of design elements, comprising:
a sheet including:
a sheet surface that is substantially planar, and is configured to receive at least one design element; and
a receiving region having a sheet engagement portion;
an insert dimensioned to fit within the receiving region, and including:
an insert surface, that is substantially planar, and is configured to receive at least one design element; and
an insert engagement portion configured to engage with the sheet engagement portion in a manner that removably secures the insert within the receiving region in a secured position, whereby the sheet surface substantially adjoins the insert surface.

2. The system of claim 1, wherein the sheet surface is substantially co-planar with the insert surface when the insert is secured within the receiving region in the secured position.

3. The system of claim 1, wherein the insert includes first and second insert surfaces that are substantially opposed to each other, and wherein the insert engagement portion is configured to selectively engage with the sheet engagement portion in manners that removably secure the insert within the receiving region in either:
a first secured position, whereby the first insert surface substantially adjoins the sheet surface; or
a second secured position, whereby the second insert surface substantially adjoins the sheet surface.

4. The system of claim 1, wherein the sheet includes first and second sheet surfaces that are substantially opposed to each other, and wherein the insert engagement portion is configured to selectively engage with the sheet engagement portion in manners that removably secure the insert within the receiving region in either:
a first secured position, whereby the insert surface substantially adjoins the first sheet surface; or
a second secured position, whereby the insert surface substantially adjoins the second sheet surface.

5. The system of claim 1, wherein the sheet and the insert are formed from semi-rigid materials that cause the sheet to substantially retain its shape under ordinary use.

6. The system of claim 5, wherein:
the receiving region is a window through the sheet that is at least partially surrounded by the sheet; and
the sheet engagement portion includes an edge of the sheet that is positioned within the window adjacent to the sheet surface, and that has a longitudinal axis that diverges from the longitudinal axis of the sheet surface.

7. The system of claim 1, wherein the sheet includes a plurality of receiving regions, and wherein the system further comprises a plurality of inserts, each dimensioned to fit securely within at least one of the plurality of receiving regions.

8. The system of claim 1, wherein each of the design elements is selected from the group consisting of: a paint, a stain, a lacquer, a veneer, a paper, a wallpaper, a tile, a fabric, a wood, a metal, a plaster, an earthen plaster, a brick, and a carpet.

9. The system of claim 1, further comprising an adhesive substance configured to adhere to, and removably secure the sheet and/or the insert to one or more structural surfaces.

10. The system of claim 1, further comprising a label configured to receive written information, and to attach to the sheet surface, to the insert surface, and/or to design elements applied to the sheet or insert surfaces.

11. A method of assessing the aesthetic compatibility of design elements, comprising:
providing a sheet including:
a sheet surface that is substantially planar, and is configured to receive at least one design element; and
a receiving region having a sheet engagement portion;
providing an insert dimensioned to fit within the receiving region, and including:
an insert surface that is substantially planar, and is configured to receive at least one design element; and
an insert engagement portion configured to engage with the sheet engagement portion in a manner that removably secures the insert within the receiving region in a secured position, whereby the sheet surface substantially adjoins the insert surface;
applying a first design element to the sheet surface;
applying a second design element to the insert surface;
securing the insert in the secured position, whereby the first design element substantially adjoins the second design element; and
assessing the aesthetic compatibility of the first design element relative to the second design element.

12. The method of claim 11, wherein the insert includes another insert surface substantially opposed to the insert surface, and wherein the insert engagement portion is configured to selectively engage with the sheet engagement portion in manners that removably secure the insert within the receiving region in either the secured position, or in a reverse secured position, whereby the sheet surface substantially adjoins the other insert surface, the method further comprising;
applying a third design element to the other insert surface;
securing the insert in the reverse secured position, whereby the first design element substantially adjoins the third design element;
assessing the aesthetic compatibility of the first design element relative to the third design element; and
comparing the aesthetic compatibility of the first design element relative to the second design element with the aesthetic compatibility of the first design element relative to the third design element.

13. The method of claim 11, wherein the first and second design elements are each selected from the group consisting of: a paint, a stain, a lacquer, a veneer, a paper, a wallpaper, a tile, a fabric, a wood, a metal, a plaster, an earthen plaster, a brick, and a carpet.

14. The method of claim 11, further comprising:
adhering an adhesive substance to an other surface of the sheet;
securing the other surface of the sheet directly to a surface of a structure with the adhesive; and
assessing the aesthetic compatibility of the first and/or second design elements relative to the structure.

15. The method of claim 11, further comprising:
labeling one or more of the applied design elements with a label configured to receive written information.

16. A method of assessing the aesthetic compatibility of design elements, comprising:
providing a sheet including:
a sheet surface that is substantially planar, and is configured to receive a design element; and
a plurality of receiving regions, each having a sheet engagement portion;
providing a plurality of inserts, each dimensioned to fit within at least a corresponding one of the plurality of receiving regions, and each having:
an insert surface that is substantially planar, and is configured to receive a design element; and
an insert engagement portion configured to engage with the sheet engagement portion of each corresponding receiving region in a manner that removably secures the insert within the corresponding receiving region in a secured position, whereby the sheet surface substantially adjoins the insert surface;
applying a design element to the sheet surface;
applying either the same or a different design element to each of the plurality of insert surfaces.
securing each of the plurality of inserts in the secured position within the corresponding receiving region, whereby the design element applied to each insert surface substantially adjoins the design element applied to the sheet surface; and
assessing the aesthetic compatibility of the various applied design elements relative to each other.

17. The method of claim 16, wherein a design element applied to any particular insert surface is different from the design element applied to the sheet surface.

18. The method of claim 16, wherein a design element applied to any particular insert surface is different from the design elements applied to any of the other insert surfaces.

19. The method of claim 16, further comprising:
adhering an adhesive substance to an other surface of the sheet;
securing the other surface of the sheet directly to a surface of a structure with the adhesive; and
assessing the aesthetic compatibility of the various applied design elements relative to the structure.

20. The method of claim 16, further comprising:
labeling one or more of the applied design elements with a label configured to receive written information.
